(19) United States
(12) Patent Application Publication
(10) Pub. No.: US 2021/0179133 A1
(43) Pub. Date: Jun. 17, 2021

(54) DRIVER ASSISTANCE METHOD AND SYSTEM FOR ALERTING A DRIVER OF A VEHICLE

(71) Applicant: Lear Corporation, Southfield, MI (US)

(72) Inventors: Arjun YETUKURI, Rochester Hills, MI (US); Ashwini Jayanth MALATKAR, Southfield, MI (US)

(73) Assignee: Lear Corporation, Southfield, MI (US)

(21) Appl. No.: 16/710,474

(22) Filed: Dec. 11, 2019

(51) Int. Cl. B60W 50/16; B60W 40/10; G06K 9/00; G08G 1/16; H04W 4/40

(52) U.S. Cl. CPC B60W 50/16; B60W 40/10; G06K 9/00805; B60W 2050/143; G08G 1/166; H04W 4/40; B60W 2550/10; G06K 9/00825

(57) ABSTRACT

A driver assistance method and system are disclosed for alerting a driver of a host vehicle. The method includes detecting that the host vehicle is stationary in a lane at an intersection having a traffic signal, receiving input indicating it is permissible for traffic in the lane to proceed through the intersection, and determining whether an object is present in front of the host vehicle in the lane. The method also includes, in response to the receipt of the input and based on the determination whether an object is present in front of the host vehicle in the lane, determining that the host has not transitioned from stationary to moving, and generating an alert for the driver in response to the determination that the host vehicle has not transitioned from stationary to moving.

### TECHNICAL FIELD

The following relates to a driver assistance method and system for alerting a driver of a host vehicle that is stationary that the host vehicle may proceed.

### BACKGROUND

Distracted driving has become an increasingly dangerous and costly problem due to various factors, including the proliferation of mobile devices and the use of such devices by vehicle drivers while driving. In 2016, distracted driving accounted for nearly 10% of fatalities on U.S. roads. Distracted driving can also be the cause of non-fatal accidents, delays, and even road rage.

One example of distracted driving is a vehicle stopped at a red traffic light and failing to proceed when the traffic light changes to green. While waiting at a red light for it to turn green, drivers often attend to non-driving activities. Eventually, when the light turns green, some drivers are in a distracted state and do not realize that the light has turned green and the driver may therefore proceed.

Such a situation may cause frustration for drivers in vehicles located behind the vehicle of the distracted driver. Such frustration may become manifest in honking and can potentially give rise to incidents of road rage between drivers. Such a situation may also create a false expectation in a driver that the driver in front will also start, which may result in a vehicle rear-end collision when the driver of the vehicle in front is distracted. Such a situation may alternatively result in minor to major traffic delays depending on the type, configuration, and/or congestion of an intersection and/or the lane in which the vehicle with the distracted driver is present (e.g., a left-turn only lane).

Current method and systems for mitigating distracted driving focus on distraction during driving (i.e., while-driving situations). Moreover, current driver alert methods and systems, such as lane departure system and vehicle blind spot detection systems, provide alerts during driving.

A need therefore exists for a driver assistance method and system that alerts a driver of a host vehicle that is stationary that the host vehicle may proceed. Such an improved driver assistance method and system for alerting a driver would help to eliminate, reduce, and/or mitigate the stopped-vehicle distracted driver situations previously described. In that regard, such an improved driver assistance method and system for alerting a driver of a stopped host vehicle would automatically assist the driver to remain focused on the task of driving, which would help to eliminate accidents, improve traffic flow, and reduce the potential for road rage incidents.

### SUMMARY

According to one non-limiting exemplary embodiment described herein, a driver assistance method is provided for alerting a driver of a host vehicle. The method comprises detecting that the host vehicle is stationary in a lane at an intersection having a traffic signal, receiving input indicating it is permissible for traffic in the lane to proceed through the intersection, and determining whether an object is present in front of the host vehicle in the lane. The method further comprises, in response to the receipt of the input and based on the determination whether an object is present in front of the host vehicle in the lane, determining that the host vehicle has not transitioned from stationary to moving, and generating an alert for the driver in response to the determination that the host vehicle has not transitioned from stationary to moving.

According to another non-limiting exemplary embodiment described herein, a driver assistance system is provided for alerting a driver of a host vehicle. The system comprise a detection unit configured to detect that the host is stationary in a lane at an intersection having a traffic signal, a receiving unit configured to receive input indicating it is permissible for traffic in the lane to proceed through the intersection, and an object determination unit configured to determine whether an object is present in front of the host vehicle in the lane. The system further comprises a vehicle movement determination unit configured to determine, in response to receipt of the input by the receiving unit and based on a determination by the object determination unit whether an object is present in front of the host vehicle in the lane, that the host vehicle has not transitioned from stationary to moving, and an alerting unit configured to generate an alert for the driver in response to the determination by the vehicle movement determination unit that the host vehicle has not transitioned from stationary to moving.

According to still another non-limiting exemplary embodiment described herein, a driver assistance method is provided for alerting a driver of a host vehicle. The method comprises detecting that the host vehicle is stationary, receiving input indicating it is permissible for the host vehicle to proceed, and determining whether an object is present in a planned path of the host vehicle. The method further comprises, in response to the receipt of the input and based on a determination whether an object is present in the planned path of the host vehicle, determining that the host vehicle has not transitioned from stationary to moving, and generating an alert for the driver in response to the determination that the host vehicle has not transitioned from stationary to moving.

A detailed description of these and other non-limiting exemplary embodiments of a driver assistance method and system for alerting a driver of a host vehicle that is stationary that the host vehicle may proceed are set forth below together with the accompanying drawings.

### BRIEF DESCRIPTION OF THE DRAWINGS

FIG. 1 is an illustration of an exemplary environment for non-limiting exemplary embodiments of a driver assistance method and system for alerting a driver of a host vehicle according to the present disclosure;

FIG. 2 is simplified block diagram of one non-limiting exemplary embodiment of a driver assistance system for alerting a driver of a host vehicle according to the present disclosure;

FIG. 3 is a simplified flowchart of one non-limiting exemplary embodiment of a driver assistance method for alerting a driver of a host vehicle according to the present disclosure; and

FIG. 4 is a table of various exemplary situations or scenarios for non-limiting exemplary embodiments of a driver assistance method and system for alerting a driver of a host vehicle according to the present disclosure.

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components, elements, features, items, members, parts, portions, or the like. Therefore, specific structural and functional details disclosed herein are not to be interpreted as limiting, but merely as a representative basis for teaching one skilled in the art.

As described previously, a need exists for a driver assistance method and system that alerts a driver of a host vehicle that is stationary that the host vehicle may proceed. Such an improved driver assistance method and system for alerting a driver would help to eliminate, reduce, and/or mitigate the stopped-vehicle distracted driver situations previously described. In that regard, such an improved driver assistance method and system for alerting a driver of a stopped host vehicle would automatically assist the driver to remain focused on the task of driving, which would help to eliminate accidents, improve traffic flow, and reduce the potential for road rage incidents.

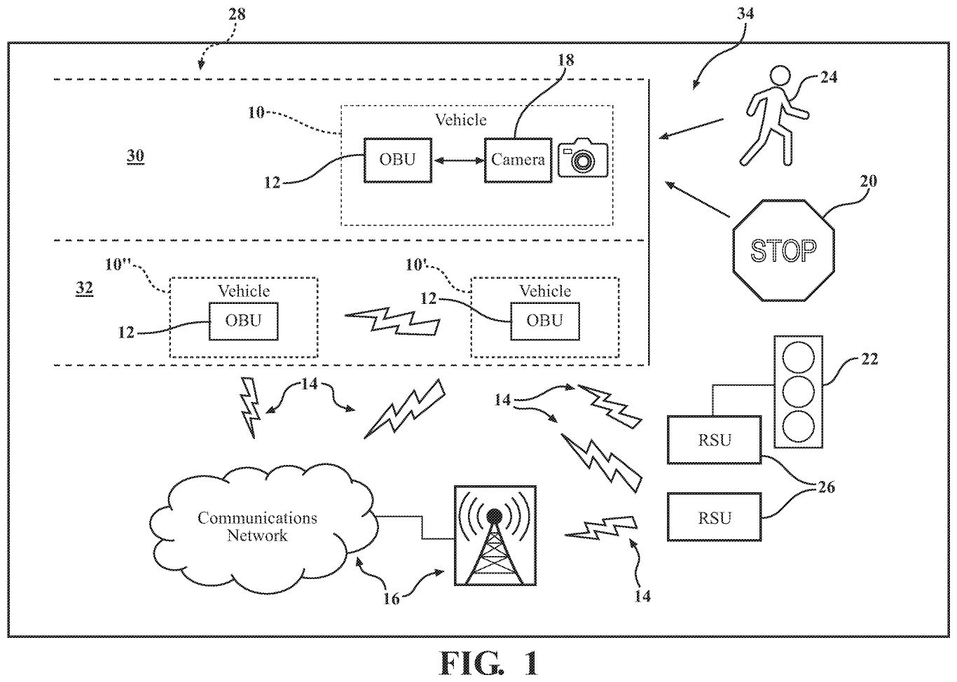

With reference now to FIGS. 1-4, a more detailed description will be provided of non-limiting exemplary embodiments of a driver assistance method and system for alerting a driver of a host vehicle that is stationary that the host vehicle may proceed. For ease of illustration and to facilitate understanding, like reference numerals have been used herein for like components and features throughout the drawings.

In general, the driver assistance method and system for alerting a driver of a stopped host vehicle according to the present disclosure is a localized alert, which may be provided for example to inform the driver that a traffic light has turned from red to green. To do so, the driver assistance method and system may utilize a haptic alert in the driver's seat of the vehicle, which may include one or more haptic motors and/or air bladders provided for use as part of a seat massage feature.

Alternatively, an audible and/or visual warning or alert may be provided to the driver, such as turning ON auxiliary/mood lights on the driver's seat or armrest. Such audible and/or visual alerts may be used along with or without any of the previously described haptic alerts. Still further, a driver alert may take the form of a seat function such as a front tilt mechanism that is automatically actuated without driver intervention, which may comprise activation of the mechanism at a higher travel rate than normal. When the vehicle is subsequently in motion, the activated feature is returned to its original position.

Input regarding the change in a traffic light from red to green may be received by a seat control module from an outward facing camera or any other suitable type of sensor (e.g., a Light Detection and Ranging (LiDAR) sensor) on-board the host vehicle. Alternatively, input regarding the change in a traffic light from red to green may be received by a seat control module from one or more wireless communication signals transmitted/received in a wireless communication system, such as vehicle-to-anything (V2X) (e.g., vehicle-to-vehicle, vehicle-to-infrastructure, vehicle-to-pedestrian) Dedicated Short Range Communications (DSRC), cellular communications, or any other type of wireless communications. One example of such a wireless communication system is CONNEXUS™ provided by Lear Corporation.

Similar alerts may be used to inform the driver of a stopped or stationary host vehicle that it is safe to turn (e.g., left turn) when at an intersection, whether in a dedicated left turn lane or not, or when not at an intersection (e.g., “Michigan left”). In that regard, a control module comprising suitable intelligence, which may comprise a control algorithm in the form of computer executable instructions, may be used to identify and/or determine a safe-to-turn time, which may utilize wireless communications and/or an on-board outward facing camera or other sensor to detect and/or provide information regarding the traffic scenario in which the host vehicle is present.

Still further, similar alerts may be used to inform the driver of a stopped or stationary host vehicle that it is safe to go at an intersection without traffic lights (e.g., a 4-way STOP intersection) or at an intersection at which the traffic lights are non-functional, such as due to a power failure or malfunction. Once again, a control module comprising suitable intelligence, which may comprise a control algorithm in the form of computer executable instructions, may be used to identify and/or determine which vehicle at the intersection arrived first and whose turn it is to proceed through the intersection, which again may utilize wireless communications and/or an on-board outward facing camera or other sensor to detect and/or provide information regarding the traffic scenario in which the host vehicle is present.

Similar alerts may also be used to inform the driver of a stopped or stationary host vehicle that it is safe to go after the host vehicle has stopped for a pedestrian. Here again, a control module comprising suitable intelligence, which may comprise a control algorithm in the form of computer executable instructions, may be used to identify the pedestrian and identify and/or determine that the pedestrian is not present in the planned path of the hose vehicle and it is safe for the host vehicle to proceed, which once again may utilize wireless communications and/or an on-board outward facing camera or other sensor to detect and/or provide information regarding the pedestrian and the traffic scenario in which the host vehicle is present.

As well, similar alerts may be used to inform the driver of a host vehicle stopped or stationary behind another vehicle because at a red light, or in z traffic jam, or at a 4-way STOP intersection that it is safe to go when the vehicle in front has proceeded. A control module comprising suitable intelligence, which may comprise a control algorithm in the form of computer executable instructions, may again be used to identify and track the vehicle in front of the host vehicle and determine that it is safe for the host vehicle to proceed, which once again may utilize wireless communications and/or an on-board outward facing camera or other sensor to detect and/or provide information regarding the vehicle in front of the host vehicle and the traffic scenario in which the host vehicle is present.

Further still, similar alerts may be used to inform the driver of a host vehicle stopped at railway tracks or a railroad crossing that an associated gate has been lifted and/or an associated traffic light has turned green. Here again, a control module comprising suitable intelligence, which may comprise a control algorithm in the form of computer executable instructions, may be used to identify and/or detect the railroad crossing and detect and/or determine that the associated gate has been raised and/or the associated traffic light has turned green and that it is safe for the host vehicle to proceed, which once again may utilize wireless communications and/or an on-board outward facing camera or other sensor to detect and/or provide information regarding the railroad crossing and the state of an associated gate and/or traffic light.

Alternatively, an alert may be generated to inform a driver of a host vehicle that it is safe to stop when the host vehicle is approaching a traffic light that is currently green but about to turn yellow or that is currently yellow but about to turn red. Such information may be received by a host vehicle control module, which may be mounted in the driver's seat, from wireless communications as previously described. Different alerts may also be used to assist a driver of a host vehicle in distinguishing between a safe-to-go alert and a safe-to-stop alert, which may comprise differences in the intensity or location of an alert. For example, a safe-to-go alert may be generated in a cushion of the driver's seat, while a safe-to-stop alert may be generated in the seat back of the driver's seat. Alternatively, a single occurrence of an alert may be used indicate a safe-to-go condition, while multiple occurrences of an alert may be used indicate a safe-to-stop condition.

Referring now to FIG. 1, an exemplary environment is illustrated for non-limiting exemplary embodiments of a driver assistance method and system for alerting a driver of a host vehicle according to the present disclosure. As seen therein, a host vehicle 10, 10′, 10″ may include an on-board unit (OBU) 12 configured for wireless communication with other similarly configured vehicles 10, 10′, 10″ via wireless signals 14 transmitted between the OBUs 12. As previously noted, such wireless signals 14 may be DSRC signals transmitted directly between the OBUs 12 or may be any other type of wireless signal, such as a cellular communication signals transmitted via wireless communication network or system 16.

The OBUs 12 may also be configured for communication with a forward-facing camera 18 or any other type of suitable sensor (e.g., LiDAR sensor) on-board the vehicle 10. Such an on-board camera 18 or sensor may sense, detect, and/or provide information regarding the environment around the vehicle 10, which may include detecting (e.g., by capturing images of) a traffic signal, such as a STOP sign 20 or a traffic control light 22, or detecting a pedestrian 24. Data or information provided by the camera 18 and/or other suitable on-board sensor and/or V2X communications may be used by a controller, control unit, or control module on-board the vehicle 10 to determine whether or not an object is present in front or in the planned path of the vehicle 10 and/or to identify any such object detected as a vehicle or a pedestrian, including determining and/or tracking the speed and direction of the detected object relative to the vehicle 10, according to any of the vehicle systems and methods for detecting, identifying, and/or tracking objects that are well known to those of ordinary skill.

Such OBUs 12 may also be configured for wireless communication with roadside units (RSU) 26 similarly configured for such wireless communication via wireless signals 14 transmitted between the OBUs 12 and the RSUs 26. In that regard, the RSUs 26 are so named because they may be located beside, around, or in the vicinity of a road 28. One or more of the RSUs 26 may be provided in communication with the traffic control light 22 and may communicate with the OBUs 12 directly via DSRC signals or alternatively via any other type of wireless signal 14, such as cellular communication signals transmitted via wireless communication network or system 16. As previously described, the wireless signals 14 transmitted from the RSUs 26 to the OBUs 12 may include data or information as to the status or condition of the traffic control light 22, such as a transition from a red light to a green light.

Still referring to FIG. 1, the vehicles 10, 10′, 10″ may be located in a lane 30, 32 of the road 28 and may be stopped or stationary at an intersection 34 associated with the road 28. In that regard, a vehicle 10, 10′, 10″ may be the first vehicle 10, 10′ at the intersection 34 (first at intersection) or may not be the first vehicle 10″ at the intersection 34 (not first at intersection).

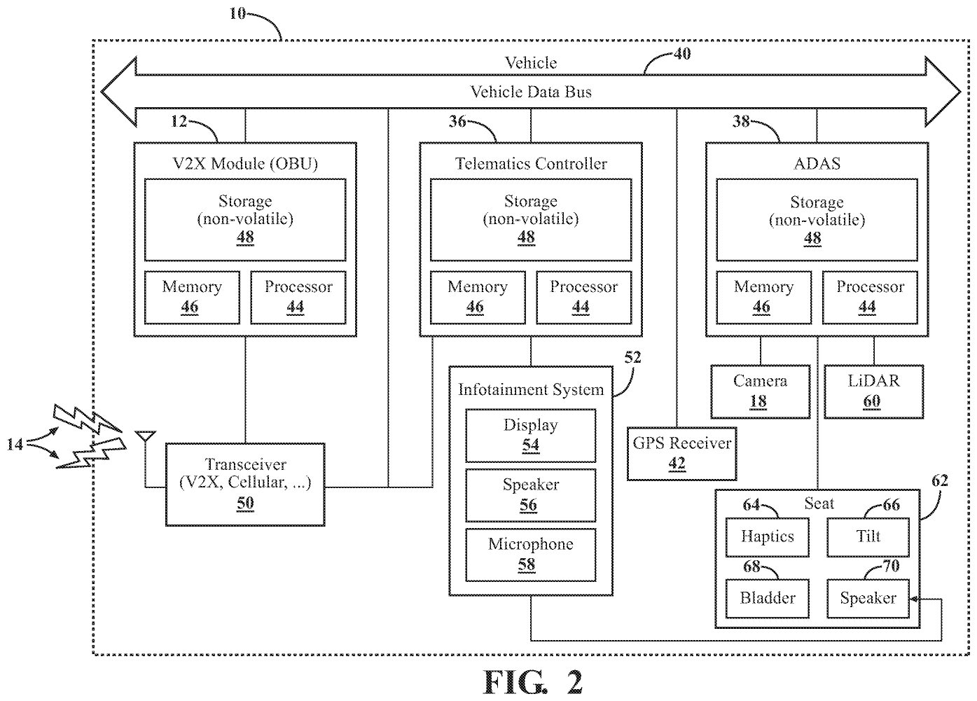

Referring next to FIG. 2, a simplified block diagram of one non-limiting exemplary embodiment of a driver assistance system for alerting a driver of a host vehicle according to the present disclosure is shown. As seen therein, a vehicle 10 may comprise an OBU 12, a telematics controller 36, and an advanced driver assistance system (ADAS) 38, each of which may be provided in communication with a vehicle data bus 40 (e.g., a Controller Area Network (CAN) bus) over which the OBU 12, the telematics controller 36, and the ADAS 38 may communicate with each other and with other components or systems of the vehicle 10 (e.g., speedometer, brake system, drive train, etc.). The vehicle 10 may also comprise a global positioning system (GPS) receiver 42, which may also be provided in communication with the vehicle data bus 40 for communicating with the OBU 12, the telematics controller 36, the ADAS 38, and/or any other components or systems of the vehicle 10.

Each of the OBU 12, the telematics controller 36, and the ADAS 38 may comprise one or more processors 44, as well as associated memory 46 and non-volatile storage 48 for storing suitable and appropriate computer executable instructions and data for the processors 44 to perform the control operations, functions, and/or algorithms described herein. In that regard, it should be noted that any unit, module, controller, system, subsystem, mechanism, device, component or the like described herein may comprise appropriate circuitry, such as one or more appropriately programmed processors (e.g., one or more microprocessors including central processing units (CPU)) (such as processors 44) and associated memory (such as memory 46 and/or storage 48), which may include stored operating system software and/or application software executable by the processor(s) for controlling operation thereof and for performing the particular algorithms represented by the various functions and/or operations described herein, including interaction between and/or cooperation with each other. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

The OBU 12, which may alternatively be referred to as a V2X module, may also be provided in communication with a transceiver 50 configured to transmit and receive wireless signals 14 for communication with the OBUs 12 of other vehicles 10′, 10″ and/or with the RSUs 26 (see FIG. 1). In that regard, such wireless signals 14 may comprise the previously described DSRC wireless signals and/or cellular communication signals transmitted via wireless communication network or system 16 (see FIG. 1).

Still referring to FIG. 2, the telematics controller 36 may be provided in communication with an infotainment system 52, which may comprise a display 54, a speaker 56, and a microphone 58. In that regard, the display 54 and/or the speaker 56 of the infotainment system 52 may be utilized to generate and/or provide the various driver alerts according to the embodiments of the driver assistance method and system of the present disclosure as described herein.

The ADAS 38 may be provided in communication with an on-board camera 18 and a LiDAR sensor 60. As previously described, the camera 18 and/or LiDAR sensor 60 may sense, detect, and/or provide information regarding the environment around the vehicle 10, which may include detecting (e.g., by capturing images of) a traffic signal, such as a STOP sign 20 or a traffic control light 22, or detecting a pedestrian 24 (see FIG. 1). Data or information provided by the camera 18 and/or LiDAR sensor 60 and/or V2X communications may be used by the ADAS 38 or another controller, control unit, or control module on-board the vehicle 10 to determine whether or not an object is present in front or in the planned path of the vehicle 10 and/or to identify any such object detected as a vehicle or a pedestrian, including determining and/or tracking the speed and direction of the detected object relative to the vehicle 10, according to any of the vehicle systems and methods for detecting, identifying and/or tracking objects that are well known to those of ordinary skill.

The ADAS 38 may further be provided in communication with a vehicle seat and/or seat controller 62, which may comprise a haptic motor 64, a seat tilt mechanism 66, an inflatable air bladder 68, and a speaker 70, which may be part of, integrated with, or operated in conjunction with the speaker 56 of the infotainment system 52. Here again, the haptic motor 64, tilt mechanism 66, bladder 68, and speaker 70 may be utilized to generate and/or provide the various driver alerts according to the embodiments of the driver assistance method and system of the present disclosure as described herein.

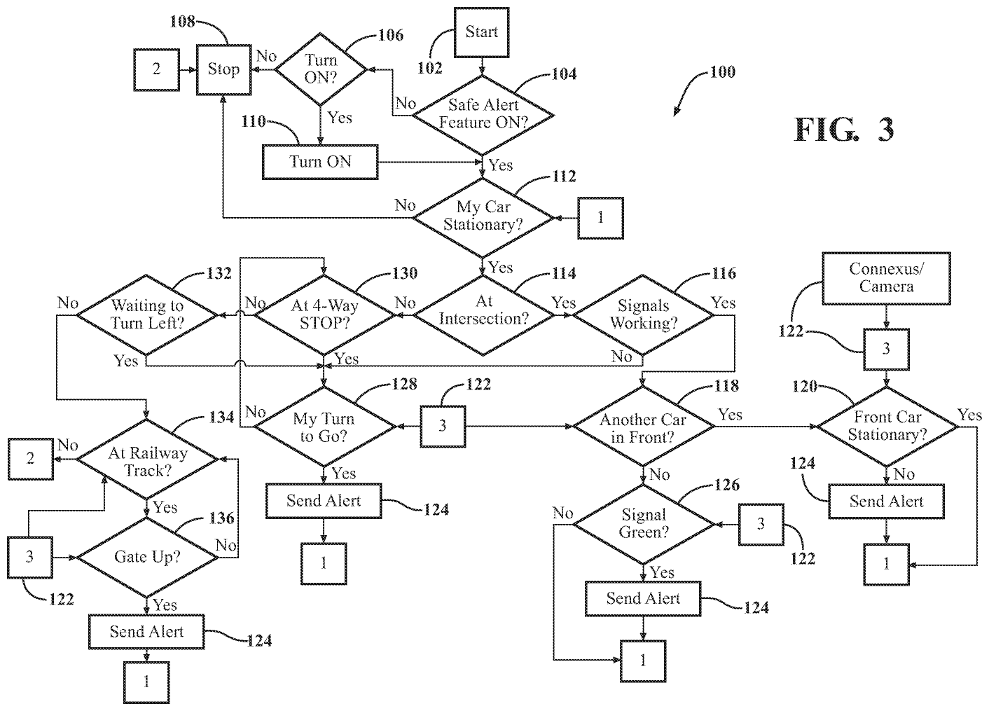

Referring now to FIG. 3, a simplified flowchart of one non-limiting exemplary embodiment of a driver assistance method 100 for alerting a driver of a host vehicle according to the present disclosure is shown. As seen therein, after start 102, a decision is made at 104 as to whether the safe alert feature of the present disclosure is on or active. If not, a decision is made at 106 as to whether that safe alert feature should be turned on or activated. If not, the method 100 ends at stop 108.

Alternatively, if a decision has been made at 104 that the safe alert feature is active, or a decision has been made at 106 to activate the safe alert feature and that feature has been activated at 110, then a decision is made at 112 as to whether the host vehicle is stationary. If not, the method 100 ends at stop 108. Alternatively, if a decision has been made at 112 that the host vehicle is stationary, then a decision is made at 114 as to whether the stationary host vehicle is located at a lighted intersection (i.e., an intersection having a traffic control light).

If a decision has been made at 114 that the stationary host vehicle is located at a lighted intersection, then a decision is made at 116 as to whether the traffic control light is operational. If so, then a decision is made at 118 as to whether another vehicle is located in front of the host vehicle. If so, then a decision is made at 120 as to whether the vehicle in front of the host vehicle is stationary. As previously described, the decision at 118 as to whether another vehicle is located in front of the host vehicle as well as the decision at 120 as to whether a vehicle in front of the host vehicle is stationary may be made based on or using input 122 in the form of data and/or information sensed, detected, provided and/or received by a camera 18 or a sensor 60 on-board the host vehicle or via a wireless signal 14 received by the OBU 12 of the host vehicle (see FIGS. 1 and 2).

If a decision has been made at 120 that the vehicle in front of the host vehicle is stationary, then control returns to the decision at 112 as to whether the host vehicle is stationary. Alternatively, if a decision has been made at 120 that the vehicle in front of the host vehicle is not stationary (i.e., the vehicle in front of the host vehicle has begun to proceed), then at 124 an alert is sent to or generated for the driver of the host vehicle according to one or more of the embodiments of the present disclosure described herein, after which control then returns to the decision at 112 as to whether the host vehicle is stationary (i.e., whether the host vehicle has begun to proceed).

Still referring to FIG. 3, if it has been decided at 118 that a vehicle is not present in front of the host vehicle, then a decision is made at 126 as to whether the traffic control signal is green. As previously described, the decision at 126 as to whether the traffic control signal is green may be made based on or using input 122 in the form of data and/or information sensed, detected, provided and/or received by a camera 18 or a sensor 60 on-board the host vehicle or via a wireless signal 14 received by the OBU 12 of the host vehicle (see FIGS. 1 and 2).

If a decision has been made at 126 that the traffic control signal is not green, then control returns to the decision at 112 as to whether the host vehicle is stationary. Alternatively, if a decision has been made at 126 that the traffic control signal is green, then at 124 an alert is sent to or generated for the driver of the host vehicle according to one or more of the embodiments of the present disclosure described herein, after which control then returns to the decision at 112 as to whether the host vehicle is stationary (i.e., whether the host vehicle has begun to proceed).

If, alternatively, at 116 a decision has been made that the traffic control signal is not operational, then a decision is made at 128 as to whether it is the host vehicle's turn to proceed. As previously described, the decision at 128 as to whether it is the host vehicle's turn to proceed may be made based on or using input 122 in the form of data and/or information sensed, detected, provided and/or received by a camera 18 or a sensor 60 on-board the host vehicle or via a wireless signal 14 received by the OBU 12 of the host vehicle (see FIGS. 1 and 2). If a decision has been made at 128 that it is the host vehicle's turn to proceed, then at 124 an alert is sent to or generated for the driver of the host vehicle according to one or more of the embodiments of the present disclosure described herein, after which control then returns to the decision at 112 as to whether the host vehicle is stationary (i.e., whether the host vehicle has begun to proceed).

Alternatively, if a decision has been made at 128 that it is not the host vehicle's turn to proceed, then a decision is made at 130 as to whether the host vehicle is located at a 4-way STOP intersection. If so, then a decision is again made at 128 as to whether it is the host vehicle's turn to proceed and control continues therefrom as previously described. Alternative, if a decision has been made at 130 that the host vehicle is not located at a 4-way STOP intersection, then a decision is made at 132 as to whether the host vehicle is waiting to turn left. If so, then a decision is again made at 128 as to whether it is the host vehicle's turn to proceed and control continues therefrom as previously described.

If, alternatively, a decision has been made at 132 that the host vehicle is not waiting to turn left, then a decision is made at 134 as to whether the host vehicle is located at a railroad crossing. If not, then the method 100 ends at stop 108. However, if a decision has been made at 134 that the host vehicle is located at a railroad crossing, then a decision is made at 136 as to whether the gate associated with the railroad crossing is in its raised position. Here again, the decision at 134 as to whether the host vehicle is located at a railroad crossing as well as the decision at 136 as to whether the gate associated with the railroad crossing is in its raised position may be made based on or using input 122 in the form of data and/or information sensed, detected, provided and/or received by a camera 18 or a sensor 60 on-board the host vehicle or via a wireless signal 14 received by the OBU 12 of the host vehicle (see FIGS. 1 and 2).

Referring still to FIG. 3, if a decision has been made at 136 that the gate associated with the railroad crossing is not in its raised position, then control returns to the decision at 134 as to whether the host vehicle remains located at a railroad crossing. Alternatively, if a decision has been made at 136 that the gate associated with the railroad crossing is in its raised position, then at 124 an alert is sent to or generated for the driver of the host vehicle according to one or more of the embodiments of the present disclosure described herein, after which control then returns to the decision at 112 as to whether the host vehicle is stationary (i.e., whether the host vehicle has begun to proceed).

It should also be noted that if a decision has been made at 114 that the host vehicle is not located at a lighted intersection (i.e., an intersection having a traffic control light), then control proceeds to the decision at 130 as to whether the host vehicle is located at a 4-way STOP intersection. From the decision at 130 as to whether the host vehicle is located at a 4-way STOP, control continues as previously described herein.

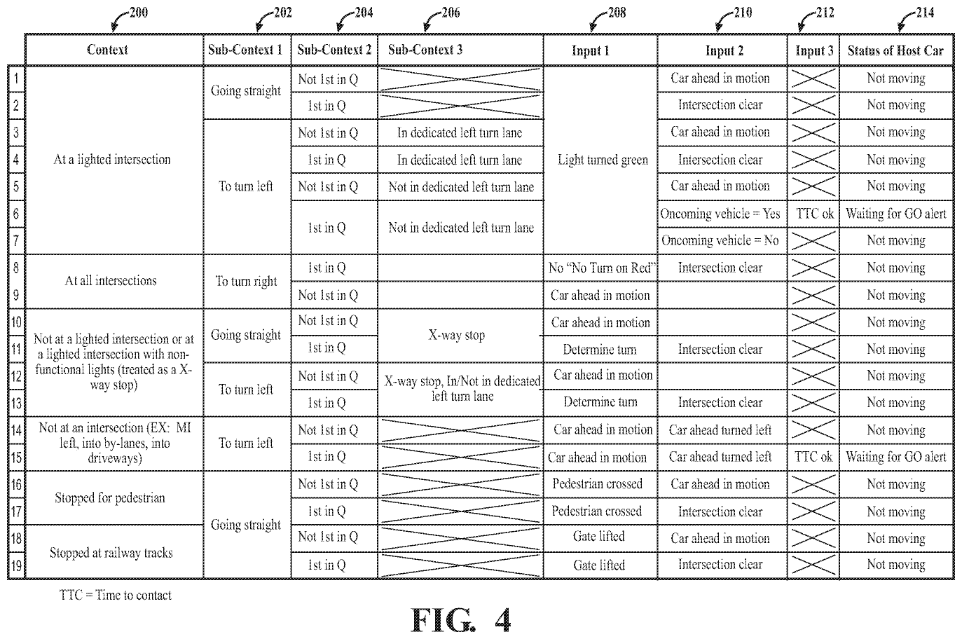

Referring now to FIG. 4, a table of various exemplary situations or scenarios for non-limiting exemplary embodiments of a driver assistance method and system for alerting a driver of a host vehicle according to the present disclosure is shown. As seen therein, each of multiple possible contexts 200 may be associated with one or more sub-contexts 202 (Sub-Context 1), 204 (Sub-Context 2), 206 (Sub-Context 3), as well as one or more inputs 208 (Input 1), 210 (Input 2), 212 (Input 3), and a host vehicle status 214.

In that regard, the contexts 200 comprise (i) at a lighted intersection (i.e., an intersection having a traffic control light); (ii) at all intersections; (iii) not at a lighted intersection or at a lighted intersection with non-functional traffic lights (treated as an X-way (e.g., 3-way, 4-way, 5-way, etc.) stop); (iv) not at an intersection (e.g., “Michigan left”, into by-lanes, into driveways); (v) stopped for a pedestrian; and (vi) stopped at railway tracks or a railroad crossing.

Sub-context 202 (Sub-Context 1) comprises (i) going straight; (ii) to turn left; and (iii) to turn right. Sub-context 204 (Sub-Context 2) comprises (i) not first in the que; and (ii) first in the que. Sub-context 206 (Sub-Context 3) comprises (i) in a dedicated left turn lane; (ii) not in a dedicated left turn lane; and (iii) X-way (e.g., 3-way, 4-way, 5-way, etc.) stop.

Input 208 (Input 1) comprises (i) light turned green; (ii) no “No Turn on Red” traffic sign; (iii) vehicle ahead (of the host vehicle) in motion; (iv) determine turn; (v) pedestrian crossed; and (vi) railroad crossing gate lifted. Input 210 (Input 2) comprises (i) vehicle ahead (of the host vehicle) in motion; (ii) intersection clear; (iii) oncoming vehicle=yes; (iv) oncoming vehicle=no; and (v) vehicle ahead (of the host vehicle) turned left. Input 212 (Input 3) comprises TTC ok, where TTC is time to contact. Host vehicle status 214 comprises (i) not moving; and (ii) waiting for GO alert.

Read from left to right, the contexts 200, sub-contexts 202, 204, 206, inputs 208, 210, 212, and host vehicle statuses 214 in the table of FIG. 4 may be selected and/or combined in various permutations to illustrate a number of different scenarios or situations for a host vehicle. That is, a given or selected context 200 may be combined with one of each sub-context 202, sub-context 204, sub-context 206 (if applicable), input 208, input 210 (if applicable), input 212 (if applicable), and host vehicle status 214 to illustrate a particular scenario or situation for a host vehicle.

For example, a host vehicle at a lighted intersection (context 200) that will be going straight (sub-context 202) may be first in the que at the intersection or not first in the que at the intersection (sub-context 202). If the host vehicle is first in the que at the intersection, the host vehicle should receive input indicating that the traffic light has turned green (input 208) and the intersection is clear (input 210) before an alert is sent to or generated for the host vehicle driver prompting the driver to proceed so that the vehicle transitions from a not moving status (host vehicle status 214). Alternatively, if the host vehicle is not first in the que at the intersection, the host vehicle should receive input indicating that that the traffic light has turned green (input 208) and the vehicle detected in front of the host vehicle is in motion (input 210) before an alert is sent to or generated for the host vehicle driver prompting the driver to proceed so that the host vehicle transitions from a not moving status (host vehicle status 214).

As is readily apparent, other combinations of contexts 200, sub-contexts 202, 204, 206, inputs 208, 210, 212, and host vehicle statuses 214 may be selected in a similar fashion to the examples provided in order to illustrate other scenarios or situations for a host vehicle. In that regard, it should be noted that the contexts 200, sub-contexts 202, 204, 206, inputs 208, 210, 212, and host vehicle statuses 214 provided in the table of FIG. 4 and the possible combinations thereof are exemplary only and not exhaustive of all possible situations or scenarios for a host vehicle in which the driver assistance method and system according to the present disclosure may be applicable.

With reference now to FIGS. 1-4, a non-limiting exemplary embodiment of a driver assistance method is provided for alerting a driver of a host vehicle. As shown and described herein, the method may comprise detecting that the host vehicle is stationary in a lane at an intersection having a traffic signal, receiving input indicating it is permissible for traffic in the lane to proceed through the intersection, and determining whether an object is present in front of the host vehicle in the lane. The method may further comprise, in response to the receipt of the input and based on the determination whether an object is present in front of the host vehicle in the lane, determining that the host vehicle has not transitioned from stationary to moving, and generating an alert for the driver in response to the determination that the host vehicle has not transitioned from stationary to moving.

As previously described, the alert may comprise an audible alert, a visual alert, or a haptic alert. Detecting that the host vehicle is stationary in the lane at the intersection may comprise determining that the host vehicle is first at the intersection or that the host vehicle is not first at the intersection. The input indicating it is permissible for traffic in the lane to proceed through the intersection may be sensed, detected, provided and/or received by a host vehicle on-board outward facing camera or via wireless communication from a traffic or communication network or system. Determining that the host vehicle has not transitioned from stationary to moving may comprise determining that the host vehicle has not transitioned from stationary to moving within a predetermined time period.

As also describe previously, an intersection may comprise a railroad crossing, a lighted intersection (i.e., and intersection having a traffic control light), or a non-lighted intersection (i.e., an intersection without a traffic control light or an intersection having a non-functional traffic control light). Moreover, a traffic signal may comprise any type of signal, such as a railway light, a traffic light, or a traffic sign (e.g., STOP sign).

Determining that the host vehicle has not transitioned from stationary to moving may comprise monitoring the host vehicle for a release of a brake pedal, a depression of an accelerator pedal, or a speed in excess of a predetermined speed threshold. In that regard, such monitoring may be accomplished based on or using data communicated over a vehicle bus from a brake system, speedometer, drive train, or other host vehicle component or system.

Determining whether an object is present in front of the host vehicle in the lane may comprise detecting an object in front of the host vehicle and/or identifying a detected object in front of the host vehicle as a vehicle and/or detecting that an object in front of the host vehicle is in motion. Determining whether an object is present in front of the host vehicle in the lane may comprise detecting and/or identifying on object as a pedestrian and/or detecting that a pedestrian is present in a planned path of the host vehicle.

Referring still to FIGS. 1-4, a non-limiting exemplary embodiment of a driver assistance system is provided for alerting a driver of a host vehicle. As shown and described herein, the system may comprise a detection unit configured to detect that the host vehicle is stationary in a lane at an intersection having a traffic signal, a receiving unit configured to receive input indicating it is permissible for traffic in the lane to proceed through the intersection, and an object determination unit configured to determine whether an object is present in front of the host vehicle in the lane. The system may further comprise a vehicle movement determination unit configured to determine, in response to receipt of the input by the receiving unit and based on a determination by the object determination unit whether an object is present in front of the host vehicle in the lane, that the host vehicle has not transitioned from stationary to moving, and an alerting unit configured to generate an alert for the driver in response to the determination by the vehicle movement determination unit that the host vehicle has not transitioned from stationary to moving.

It should be noted that the detection unit, the receiving unit, the object determination unit, the vehicle movement determination unit, and the alerting unit may take the form of, comprise, or be comprised in or by any or all of the OBU or V2X module 12, the telematics controller 36, the ADAS 38, or any other controller on-board a host vehicle 10 (see FIG. 2). It should further be noted that the detection unit, the receiving unit, the object determination unit, the vehicle movement determination unit, the alerting unit, and any other unit, module, controller, system, subsystem, mechanism, device, component or the like described herein may comprise appropriate circuitry, such as one or more appropriately programmed processors (e.g., one or more microprocessors including central processing units (CPU)) (such as processors 44) and associated memory (such as memory 46 and/or storage 48), which may include stored operating system software and/or application software executable by the processor(s) for controlling operation thereof and for performing the particular algorithms represented by the various functions and/or operations described herein, including interaction between and/or cooperation with each other. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

As previously described, the receiving unit may comprise a host vehicle on-board outward facing camera or sensor, or a receiver configured to receive wireless signals from a traffic or communication network or system. The detecting unit may be further configured to detect that the host vehicle is first at the intersection or that the host vehicle is not first at the intersection. The object determination unit may be further configured to determine to detect an object in front of the host vehicle and/or detect that an object in front of the host vehicle is in motion. The object determination unit may be further configured to detect and/or identify a pedestrian and/or detect that a pedestrian is present in a planned path of the host vehicle.

Once again, the alert may comprise an audible alert, a visual alert, or a haptic alert as previously described herein. Moreover, the vehicle movement determination unit may be configured to monitor the host vehicle for a release of a brake pedal, a depression of an accelerator pedal, or a speed in excess of a predetermined speed threshold. Such monitoring may be accomplished by the vehicle movement determination unit based on or using data communicated over a vehicle bus from a brake system, speedometer, drive train, or other host vehicle component or system.

Still referring to FIGS. 1-4, another non-limiting exemplary embodiment of a driver assistance method is provided for alerting a driver of a host vehicle. As shown and described herein, the method may comprise detecting that the host vehicle is stationary, receiving input indicating it is permissible for the host vehicle to proceed, and determining whether an object is present in a planned path of the host vehicle. The method may further comprise, in response to the receipt of the input and based on a determination whether an object is present in the planned path of the host vehicle, determining that the host vehicle has not transitioned from stationary to moving, and generating an alert for the driver in response to the determination that the host vehicle has not transitioned from stationary to moving.

Once again, the alert may comprise an audible alert, a visual alert, or a haptic alert as described previously. Moreover, the input indicating it is permissible for the host vehicle to proceed may be sensed, detected, provided and/or received by a host vehicle on-board outward facing camera or via wireless communication from a traffic or communication network or system.

Determining whether an object is present in a planned path of the host vehicle comprises detecting an object in the planned path of the host vehicle and/or identifying a detected object in the planned path of the host vehicle as a vehicle and/or detecting that an object in the planned path of the host vehicle is in motion. Determining whether an object is present in a planned path of the host vehicle may comprise detecting and/or identifying an object as a pedestrian and or detecting that a pedestrian is present in a planned path of the host vehicle.

As is readily apparent from the foregoing, various non-limiting exemplary embodiments of a driver assistance method and system for alerting a driver of a host vehicle have been described. The driver assistance method and system of the present disclosure alert a driver of a host vehicle that is stationary that the host vehicle may proceed. In such a fashion, the driver assistance method and system of the present disclosure help to eliminate, reduce, and/or mitigate the stopped-vehicle distracted driver situations described herein. In that regard, the driver assistance method and system of the present disclosure for alerting a driver of a host vehicle automatically assist the driver to remain focused on the task of driving, which help to eliminate accidents, improve traffic flow, and reduce the potential for road rage incidents.

While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

1. A driver assistance method for alerting a driver of a host vehicle comprising:
detecting that the host vehicle is stationary in a lane at an intersection having a traffic signal;
receiving input indicating it is permissible for traffic in the lane to proceed through the intersection;
determining whether an object is present in a planned path of the host vehicle, wherein the planned path comprises a route in which the host vehicle will depart from the lane based on an execution of a turning maneuver by the host vehicle;
in response to the receipt of the input and based on the determination whether an object is present the planned path of the host vehicle, determining that the host vehicle has not transitioned from stationary to moving; and
generating an alert for the driver in response to the determination that the host vehicle has not transitioned from stationary to moving.

2. The driver assistance method of claim 1 wherein the alert comprises an audible alert, a visual alert, or a haptic alert.

3. The driver assistance method of claim 1 wherein detecting that the host vehicle is stationary in the lane at the intersection comprises determining that the host vehicle is first at the intersection or that the host vehicle is not first at the intersection.

4. The driver assistance method of claim 1 wherein the input is received by via a host vehicle on-board outward facing camera or sensor, or via wireless communication from a traffic system.

5. The driver assistance method of claim 1 wherein determining that the host vehicle has not transitioned from stationary to moving comprises determining that the host vehicle has not transitioned from stationary to moving within a predetermined time period.

6. The driver assistance method of claim 1 wherein the intersection comprises a railroad crossing, a lighted intersection, or a non-lighted intersection, and wherein the traffic signal comprises a railway light, a traffic light, or a traffic sign.

7. The driver assistance method of claim 1 wherein determining that the host vehicle has not transitioned from stationary to moving comprises monitoring the host vehicle for a release of a brake pedal, a depression of an accelerator pedal, or a speed in excess of a predetermined speed threshold.

8. The driver assistance method of claim 1 wherein determining whether an object is present in front of the host vehicle in the lane comprises detecting that an object in front of the host vehicle is in motion.

9. The driver assistance method of claim 1 wherein determining whether an object is present in front of the host vehicle in the lane comprises detecting that a pedestrian is present in a planned path of the host vehicle.

10. A driver assistance system for alerting a driver of a host vehicle comprising:
a detection unit configured to detect that the host vehicle is stationary in a lane at an intersection having a traffic signal;
a receiving unit configured to receive input indicating it is permissible for traffic in the lane to proceed through the intersection;
an object determination unit configured to determine whether an object is present in a planned path of the host vehicle, wherein the planned path comprises a route in which the host vehicle will depart from the lane based on an execution of a turning maneuver by the host vehicle;
a vehicle movement determination unit configured to determine, in response to receipt of the input by the receiving unit and based on a determination by the object determination unit whether an object is present in the planned path of the host vehicle in the lane, that the host vehicle has not transitioned from stationary to moving; and
an alerting unit configured to generate an alert for the driver in response to the determination by the vehicle movement determination unit that the host vehicle has not transitioned from stationary to moving.

11. The driver assistance system of claim 10 wherein the receiving unit comprises a host vehicle on-board outward facing camera or sensor, or a receiver configured to receive wireless signals from a traffic system.

12. The driver assistance system of claim 10 wherein the detecting unit is further configured to detect that the host vehicle is first at the intersection or that the host vehicle is not first at the intersection.

13. The driver assistance system of claim 10 wherein the object determination unit is further configured to determine whether an object detected in front of the host vehicle is in motion.

14. The driver assistance system of claim 10 wherein the alert comprises an audible alert, a visual alert, or a haptic alert.

15. The driver assistance system of claim 10 wherein the vehicle movement determination unit is configured to monitor the host vehicle for a release of a brake pedal, a depression of an accelerator pedal, or a speed in excess of a predetermined speed threshold.

16. A driver assistance method for alerting a driver of a host vehicle comprising:
detecting that the host vehicle is stationary in a lane of a vehicle roadway;
receiving input indicating it is permissible for the host vehicle to proceed;
determining whether an object is present in a planned path of the host vehicle, wherein the planned path comprises a route in which the host vehicle will depart from the lane based on an execution of a turning maneuver by the host vehicle;
in response to the receipt of the input and based on a determination whether an object is present in the planned path of the host vehicle, determining that the host vehicle has not transitioned from stationary to moving; and
generating an alert for the driver in response to the determination that the host vehicle has not transitioned from stationary to moving.

17. The driver assistance method of claim 16 wherein the alert comprises an audible alert, a visual alert, or a haptic alert.

18. The driver assistance method of claim 16 wherein the input is received via a host vehicle on-board outward facing camera or sensor, or via a wireless signal from a traffic system.

19. The driver assistance method of claim 16 wherein determining whether an object is present in a planned path of the host vehicle comprises detecting an object in the planned path of the host vehicle and whether the object is in motion.

20. The driver assistance method of claim 16 wherein determining whether an object is present in a planned path of the host vehicle comprises detecting that a pedestrian is present in a planned path of the host vehicle.
